(19) United States
(12) Patent Application Publication
(10) Pub. No.: US 2026/0332732 A1
(43) Pub. Date: Oct. 22, 2026

(54) SETTING METHOD FOR THREE-DIMENSIONAL IMAGE CAPTURE AND SYSTEM FOR THREE-DIMENSIONAL IMAGE CAPTURE

(71) Applicant: InnoLux Corporation, Miao-Li County (TW)

(72) Inventors: Hao-Yu LIOU, Miao-Li County (TW); Wei-Yi LU, Miao-Li County (TW); Wei-Jen CHEN, Miao-Li County (TW); Hung-Wen YANG, Miao-Li County (TW)

(21) Appl. No.: 19/654,261

(22) Filed: Apr. 21, 2026

Related U.S. Application Data
(60) Provisional application No. 63/792,312, filed on Apr. 22, 2025.

(51) Int. Cl. H04N 13/117; H04N 13/302; H04N 13/383

(52) U.S. Cl. CPC H04N 13/117; H04N 13/302; H04N 13/383

(57) ABSTRACT

A setting method and a system for three-dimensional image capture are provided. The setting method comprises: obtaining a spatial coordinate of a left viewpoint and a spatial coordinate of a right viewpoint of at least one observer; setting spatial coordinates of at least two virtual cameras according to the spatial coordinates of the left and right viewpoints, wherein the at least two virtual cameras comprise a first virtual camera and a second virtual camera; and adjusting an optical axis offset of the first and second virtual cameras, such that a field of view of the first virtual camera is aligned with an edge of a virtual display plane, and a field of view of the second virtual camera is aligned with the edge of the virtual display plane.

### BACKGROUND

### Field of the Disclosure

The present disclosure relates to a setting method for three-dimensional image capture and a system for three-dimensional image capture, and more particularly to a setting method for three-dimensional image capture and a system for three-dimensional image capture applied to autostereoscopic three-dimensional displays.

### Description of Related Art

Three-dimensional image display technology has a wide range of applications, such as in consumer electronics, entertainment, automotive, and healthcare fields. In recent years, the pursuit of three-dimensional display effects by consumers has accelerated the development of three-dimensional image display technology. Traditionally, three-dimensional displays require wearable devices for viewing, which results in a poor user experience, thereby prompting the emergence of autostereoscopic three-dimensional image display technology.

However, current autostereoscopic three-dimensional image displays still have visual defects, such as a discrepancy between the displayed stereoscopic image and the real world. Furthermore, eye fatigue and/or discomfort caused by long-term viewing of stereoscopic images have not yet been improved.

Therefore, there is an urgent need to provide a method and system applied to autostereoscopic three-dimensional displays to improve the conventional defects.

### SUMMARY

The present disclosure provides a setting method for three-dimensional image capture, comprising the following steps: obtaining a spatial coordinate of a left viewpoint and a spatial coordinate of a right viewpoint of at least one observer; setting spatial coordinates of at least two virtual cameras according to the spatial coordinate of the left viewpoint and the spatial coordinate of the right viewpoint, wherein the at least two virtual cameras comprise a first virtual camera and a second virtual camera; and adjusting an optical axis offset of the first virtual camera and the second virtual camera, such that a field of view of the first virtual camera is aligned with an edge of a virtual display plane, and the field of view of the second virtual camera is aligned with the edge of the virtual display plane.

The present disclosure further provides a system for three-dimensional image capture, comprising: a sensing unit configured to obtain a spatial coordinate of a left viewpoint and a spatial coordinate of a right viewpoint of at least one observer; and a processing unit communicatively coupled to the sensing unit, wherein the processing unit is configured to set spatial coordinates of at least two virtual cameras according to the spatial coordinate of the left viewpoint and the spatial coordinate of the right viewpoint, wherein the at least two virtual cameras comprise a first virtual camera and a second virtual camera, and adjust an optical axis offset of the first virtual camera and the second virtual camera, such that a field of view of the first virtual camera is aligned with an edge of a virtual display plane, and the field of view of the second virtual camera is aligned with the edge of the virtual display plane.

### BRIEF DESCRIPTION OF THE DRAWINGS

FIG. 1 is a schematic diagram of a system for three-dimensional image capture according to an embodiment of the present disclosure.

FIG. 2 is a flow block diagram of a setting method for three-dimensional image capture according to an embodiment of the present disclosure.

FIG. 3A and FIG. 3B are schematic diagrams of a setting method for three-dimensional image capture according to an embodiment of the present disclosure.

FIG. 4 is a schematic diagram of an optical axis offset according to an embodiment of the present disclosure.

FIG. 5 is a schematic diagram of a setting method for three-dimensional image capture according to an embodiment of the present disclosure.

FIG. 6 is a schematic diagram of a setting method for three-dimensional image capture according to an embodiment of the present disclosure.

FIG. 7 is a schematic diagram of a viewpoint center according to an embodiment of the present disclosure.

### DESCRIPTION OF THE EMBODIMENTS

The setting method and system of the embodiments of the present disclosure are described in detail below. It should be understood that the following description provides many different embodiments to implement different aspects of some embodiments of the present disclosure. The specific elements and arrangements described below are only for a simple and clear description of some embodiments of the present disclosure. Of course, these are for illustrative purposes only and are not intended to limit the present disclosure. In addition, similar and/or corresponding reference numerals may be used in different embodiments to denote similar and/or corresponding elements for a clear description of the present disclosure. However, the use of these similar and/or corresponding reference numerals is only for a simple and clear description of some embodiments of the present disclosure and does not represent any relationship between the different embodiments and/or structures discussed.

The embodiments of the present disclosure can be understood in conjunction with the drawings, and the drawings of the present disclosure are also considered as part of the disclosure. It should be understood that the drawings of the present disclosure are not drawn to scale. In fact, the dimensions of the elements may be arbitrarily enlarged or reduced to clearly show the features of the present disclosure. In addition, the directional terms mentioned in the present disclosure, such as “upper”, “lower”, “front”, “rear”, “left”, “right”, etc., are only for reference to the directions of the drawings. Therefore, the directional terms used are for illustration and not for limiting the present disclosure.

In the present disclosure, a structure (or layer, component, substrate) described as being on/above another structure (or layer, component, substrate) may mean that the two structures are adjacent and directly connected, or it may mean that the two structures are adjacent but not directly connected. Non-direct connection means that there is at least one intermediate structure (or intermediate layer, intermediate component, intermediate substrate, intermediate space) between the two structures. The lower surface of one structure is adjacent to or directly connected to the upper surface of the intermediate structure, and the upper surface of the other structure is adjacent to or directly connected to the lower surface of the intermediate structure. The intermediate structure may be composed of a single-layer or multi-layer physical structure or non-physical structure, and is not limited. In the present disclosure, “one element corresponds to another element” means, for example, that in the normal direction of the electronic device, the element and the other element are at least partially overlapped with each other, but is not limited thereto. In addition, the term “electrically connected” includes any direct and indirect means of electrical connection.

It should be understood that ordinal numbers such as “first”, “second”, etc., used in the specification and claims to modify elements do not in themselves imply or represent that the element(s) have any preceding ordinal number, nor do they represent the order of one element relative to another, or the order in a manufacturing method. The use of these ordinal numbers is only to clearly distinguish an element with a certain name from another element with the same name. The same terms may not be used in the claims and the specification. For example, a first element in the specification may be a second element in the claims.

In the present disclosure, the terms “about”, “substantially”, and “approximately” generally mean within 10%, or within 5%, or within 3%, or within 2%, or within 1%, or within 0.5% of a given value or range. Unless otherwise specified, the term “a range between a first value and a second value” means that the range includes the first value, the second value, and other values there between. Furthermore, any two values or directions used for comparison may have a certain error. If a first value is equal to a second value, it implies that there may be an error of about 10% between the first value and the second value; if a first direction is perpendicular to a second direction, the angle between the first direction and the second direction may be between 80 degrees and 100 degrees; if a first direction is parallel to a second direction, the angle between the first direction and the second direction may be between 0 degrees and 10 degrees.

It should be understood that the following embodiments may be modified by replacing, reorganizing, and combining features from several different embodiments to complete other embodiments without departing from the spirit of the present disclosure. The features of each embodiment can be arbitrarily combined and used as long as they do not violate the spirit of the disclosure or conflict with each other.

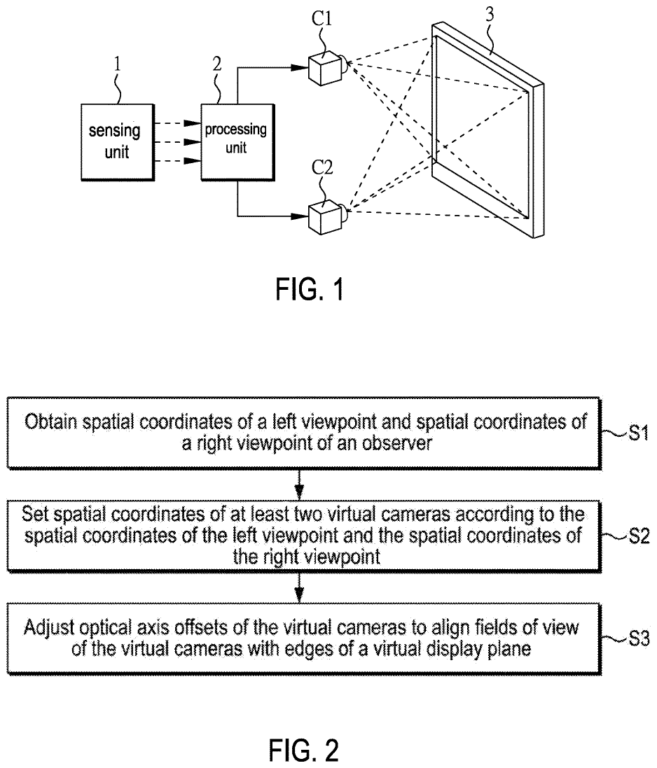

FIG. 1 is a schematic diagram of a system for three-dimensional image capture according to an embodiment of the present disclosure. The system for three-dimensional image capture and the three-dimensional display apparatus of the present disclosure can be specifically applied to mobile phones, tablet computers, public information displays (PID), or virtual reality/augmented reality (AR/VR) devices, but are not limited thereto.

In an embodiment of the present disclosure, as shown in FIG. 1, a system for three-dimensional image capture may comprise: a sensing unit 1, configured to obtain a spatial coordinate of a left viewpoint and a spatial coordinate of a right viewpoint of at least one observer (not shown); and a processing unit 2, communicatively coupled to the sensing unit 1, wherein the processing unit 2 is configured to set spatial coordinates of at least two virtual cameras according to the spatial coordinate of the left viewpoint and the spatial coordinate of the right viewpoint. The at least two virtual cameras may comprise a first virtual camera C1 and a second virtual camera C2. The processing unit 2 adjusts an optical axis offset of the first virtual camera C1 and the second virtual camera C2, such that a field of view of the first virtual camera C1 is aligned with an edge of a virtual display plane, and a field of view of the second virtual camera C2 is aligned with the edge of the virtual display plane. The system for three-dimensional image capture may further comprise an autostereoscopic three-dimensional display 3, communicatively coupled to the processing unit 2. The autostereoscopic three-dimensional display 3 can adjust display pixels according to data provided by the processing unit 2, so that the three-dimensional image of the autostereoscopic three-dimensional display 3 approaches the real world. In more detail, the processing unit 2 can provide the positional relationship between the spatial coordinates of the virtual cameras and the autostereoscopic three-dimensional display 3, calculate light projection paths and convert them into display data, so that the autostereoscopic three-dimensional display 3 displays a three-dimensional image.

In the present disclosure, the sensing unit 1 may be an eye tracker, used to track the position of the observer's left viewpoint and the position of the right viewpoint. In the present disclosure, the processing unit 2 may comprise a central processing unit (CPU), a digital signal processor (DSP), an application specific integrated circuit (ASIC), a programmable logic device (PLD), a microprocessor, other suitable processing circuits, or a combination of the foregoing. In the present disclosure, the autostereoscopic three-dimensional display 3 is an autostereoscopic three-dimensional image display with a three-dimensional image display function. The autostereoscopic three-dimensional display 3 may comprise liquid crystal or light-emitting diodes. The light-emitting diodes may, for example, comprise organic light-emitting diodes (OLED), mini light-emitting diodes (mini LED), micro light-emitting diodes (micro LED), or quantum dot light-emitting diodes (quantum dot LED, which may be, for example, QLED, QDLED), fluorescence, phosphor, other suitable materials, or a combination of the above, but the present disclosure is not limited thereto. In the present disclosure, the “communicatively coupled” may comprise a wired and/or wireless connection between two elements, so that signals can be transmitted and received between the two elements. In an embodiment, the size of the virtual display plane may be, for example, the same as the size of the autostereoscopic three-dimensional display 3, but the present disclosure is not limited thereto. The “size of the autostereoscopic three-dimensional display 3” refers to, for example, the area of the display area of the autostereoscopic three-dimensional display 3. In an embodiment, the position of the virtual cameras and the size of the virtual display plane can maintain the same relative relationship, and the size of each unit can be normalized.

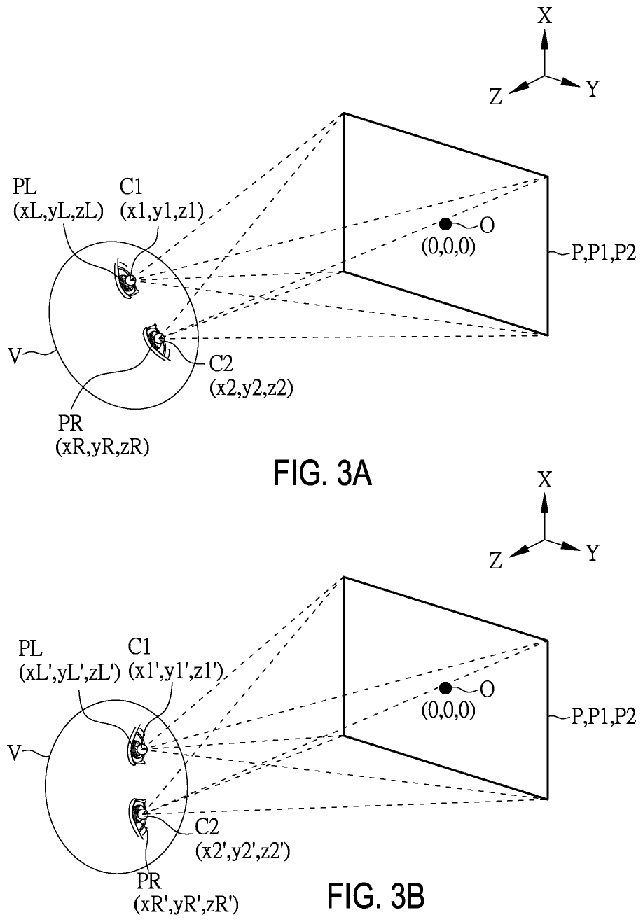

FIG. 2 is a flow block diagram of a setting method for three-dimensional image capture according to an embodiment of the present disclosure. FIG. 3A and FIG. 3B are schematic diagrams of a setting method for three-dimensional image capture according to an embodiment of the present disclosure.

In an embodiment of the present disclosure, as shown in FIG. 2 and FIG. 3A, the setting method for three-dimensional image capture may comprise steps S1 to S3. When the camera setting in the autostereoscopic three-dimensional display apparatus adopts the setting method for three-dimensional image capture described in the present disclosure, the three-dimensional image of the autostereoscopic three-dimensional display 3 (as shown in FIG. 1) can approach the real world. In step S1, a spatial coordinate of a left viewpoint PL and a spatial coordinate of a right viewpoint PR of an observer V are obtained. More specifically, a center O of a virtual display plane P is used as a reference point to define its spatial coordinates, thereby obtaining the spatial coordinate of the left viewpoint PL, for example, represented by (xL, yL, zL), and the spatial coordinate of the right viewpoint PR, for example, represented by (xR, yR, zR). Both the spatial coordinate of the left viewpoint PL and the spatial coordinate of the right viewpoint PR are defined relative to the spatial coordinate of the center O of the virtual display plane P. In an embodiment, the spatial coordinate of the center O of the virtual display plane P may be, for example, (0, 0, 0), but the present disclosure is not limited thereto.

In step S2, spatial coordinates of at least two virtual cameras are set according to the spatial coordinate of the left viewpoint PL and the spatial coordinate of the right viewpoint PR, wherein the at least two virtual cameras may comprise a first virtual camera C1 and a second virtual camera C2. The spatial coordinate of the first virtual camera C1 is, for example, represented by (x1, y1, z1), and the spatial coordinate of the second virtual camera C2 is, for example, represented by (x2, y2, z2). In an embodiment, as shown in FIG. 3A, the spatial coordinate of the first virtual camera C1 may be substantially the same as the spatial coordinate of the left viewpoint PL, and the spatial coordinate of the second virtual camera C2 may be substantially the same as the spatial coordinate of the right viewpoint PR, that is, (x1, y1, z1) may be substantially equal to (xL, yL, zL), and (x2,y2, z2) may be substantially equal to (xR, yR, zR), but the present disclosure is not limited thereto.

In step S3, an optical axis offset of the first virtual camera C1 and the second virtual camera C2 is adjusted, such that a field of view of the first virtual camera C1 is aligned with an edge of the virtual display plane P, and a field of view of the second virtual camera C2 is aligned with the edge of the virtual display plane P. In an embodiment, as shown in FIG. 3A, the step of aligning the field of view of the first virtual camera C1 and the field of view of the second virtual camera C2 with the edge of the virtual display plane P may comprise aligning the field of view of the first virtual camera C1 with spatial coordinates of four corner points of the virtual display plane P, and aligning the field of view of the second virtual camera C2 with the spatial coordinates of the four corner points of the virtual display plane P. In an embodiment, as shown in FIG. 3A, the field of view of the first virtual camera C1 may be defined, for example, by a virtual first plane P1 projected by 4 light rays (dashed lines), and the field of view of the second virtual camera C2 may be defined, for example, by a virtual second plane P2 projected by 4 light rays (dashed lines). The step of aligning the field of view of the first virtual camera C1 and the field of view of the second virtual camera C2 with the edge of the virtual display plane P may comprise substantially overlapping the virtual first plane P1 and the virtual second plane P2 with the virtual display plane P.

In the present disclosure, when the left viewpoint PL and the right viewpoint PR of the observer V move, the spatial coordinates of the at least two virtual cameras are correspondingly set, such that the field of view of the first virtual camera C1 and the field of view of the second virtual camera C2 are kept aligned with the edge of the virtual display plane P. In more detail, as shown in FIG. 1, FIG. 3A, and FIG. 3B, when the spatial coordinate of the left viewpoint PL of the observer V moves from (xL, yL, zL) to (xL′, yL′, zL′), and the spatial coordinate of the right viewpoint PR of the observer V moves from (xR, yR, zR) to (xR′, yR′, zR′), the sensing unit 1 can obtain the viewpoint position of the observer V and provide the viewpoint position to the processing unit 2 at any time. The processing unit 2 can correspondingly set or update the spatial coordinates of the at least two virtual cameras according to the change in the spatial coordinate of the left viewpoint PL and the spatial coordinate of the right viewpoint PR obtained by the sensing unit 1, for example, updating the spatial coordinate of the first virtual camera C1 from (x1, y1, z1) to (x1′, y1′, z1′), and updating the spatial coordinate of the second virtual camera C2 from (x2, y2, z2) to (x2′, y2′, z2′). By having the processing unit 2 adjust the optical axis offset of the first virtual camera C1 and the second virtual camera C2, the field of view of the first virtual camera C1 and the field of view of the second virtual camera C2 are always kept aligned with the edge of the virtual display plane P. In this way, the three-dimensional image of the autostereoscopic three-dimensional display 3 can approach the real world.

In an embodiment, when the autostereoscopic three-dimensional display 3 is fixed, and the observer V arbitrarily moves their head position or angle in front of the autostereoscopic three-dimensional display 3, the sensing unit 1 can obtain the viewpoint position of the observer V at any time and provide it to the processing unit 2. The processing unit 2 can set the position of the virtual cameras according to the viewpoint position of the observer V, and convert the relevant information into display data through calculation to provide to the autostereoscopic three-dimensional display 3, so that the observer V can correspondingly observe various image changes to maintain a correct sense of perspective. In this system, the virtual display plane P can be fixed and can be defined for a single or multiple virtual cameras. In an embodiment, when the relative position between the observer V and the autostereoscopic three-dimensional display 3 is fixed, and the entire system (including the virtual cameras and the virtual display plane P) is, for example, rotated, moved, or scaled, the processing unit 2 can convert relevant information such as the change in the spatial coordinates of the virtual cameras into display data and provide it to the autostereoscopic three-dimensional display 3, so that the observer V can correspondingly observe various image changes such as rotation, movement, or scaling. In this system, the virtual display plane P can be movable and rotatable.

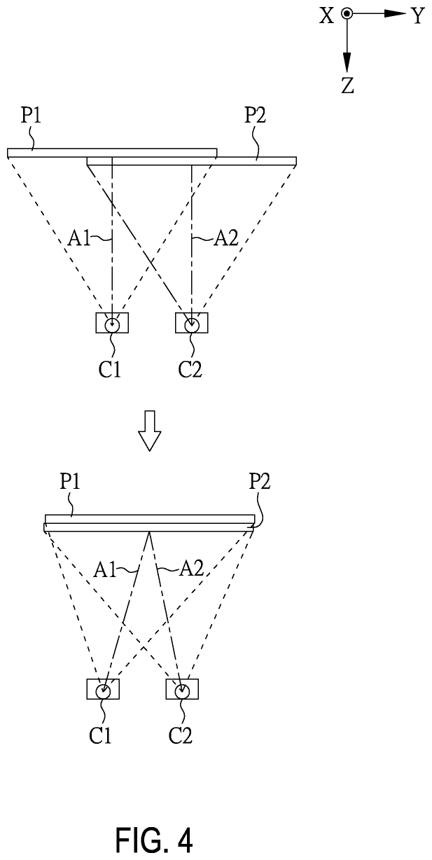

FIG. 4 is a schematic diagram of an optical axis offset according to an embodiment of the present disclosure.

As shown in FIG. 4, viewed from a top-down direction, the field of view of the first virtual camera C1 may be defined, for example, by a virtual first plane P1, and the field of view of the second virtual camera C2 may be defined, for example, by a virtual second plane P2. Generally, the optical axis of a camera is set at the center of symmetry of the system, that is, a first optical axis A1 of the first virtual camera C1 is perpendicular to the virtual first plane P1 and the viewing angle of the first virtual camera C1 is symmetrical left and right, and a second optical axis A2 of the second virtual camera C2 is perpendicular to the virtual second plane P2 and the viewing angle of the second virtual camera C2 is symmetrical left and right. A three-dimensional image can be displayed where the virtual first plane P1 and the virtual second plane P2 overlap.

Before adjusting the optical axis offset, the overlapping area of the virtual first plane P1 and the virtual second plane P2 is small, resulting in a small range of the displayed three-dimensional image or a mismatch with the real world. By offsetting the first optical axis A1 of the first virtual camera C1 and the second optical axis A2 of the second virtual camera C2, the virtual first plane P1 and the virtual second plane P2 can be made to overlap, thereby making the three-dimensional image approach the real world. In more detail, as shown in FIG. 4, the first optical axis A1 of the first virtual camera C1 can be adjusted, for example, by offsetting it to the right, and the second optical axis A2 of the second virtual camera C2 can be adjusted, for example, by offsetting it to the left, so that the virtual first plane P1 and the virtual second plane P2 substantially overlap. At this time, due to the offset of the first optical axis A1 and the second optical axis A2, the first optical axis A1 will not be perpendicular to the virtual first plane P1, and the second optical axis A2 will not be perpendicular to the virtual first plane P2; and the viewing angle of the first virtual camera C1 is asymmetrical left and right, and the viewing angle of the second virtual camera C2 is asymmetrical left and right. In an implementation, an Asymmetric Projection Matrix can be used when processing the virtual cameras in software to achieve the optical axis offset, but it is not limited to this.

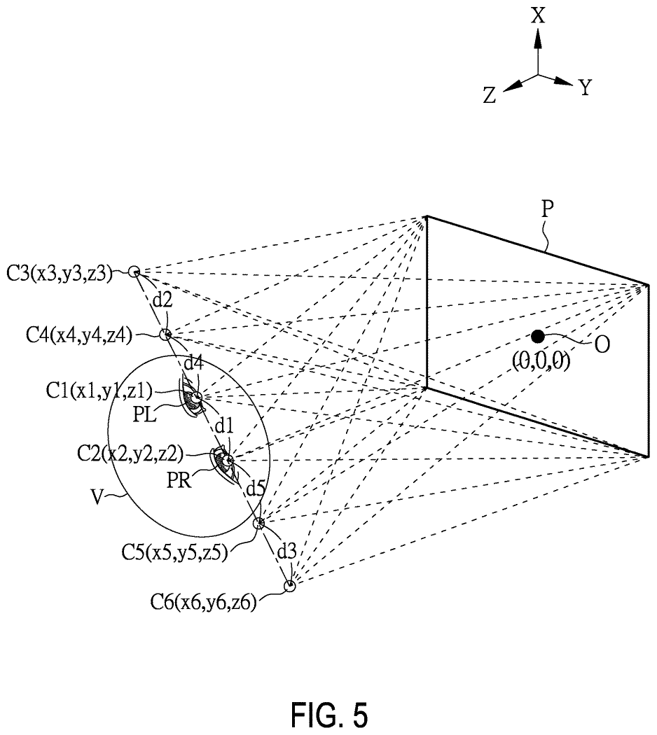

FIG. 5 is a schematic diagram of a setting method for three-dimensional image capture according to an embodiment of the present disclosure.

In an embodiment of the present disclosure, in addition to the aforementioned steps, the setting method for three-dimensional image capture may further comprise: the processing unit 2 (as shown in FIG. 1) setting a spatial coordinate of a virtual camera array according to the spatial coordinates of the at least two virtual cameras; and adjusting an optical axis offset of each virtual camera in the virtual camera array, such that a field of view of each virtual camera in the virtual camera array is aligned with the edge of the virtual display plane P, thereby causing the autostereoscopic three-dimensional display 3 (as shown in FIG. 1) to generate multi-view images. In an embodiment, when the system targets a single observer V, the processing unit 2 (as shown in FIG. 1) can calculate the position and parameters of each virtual camera in the virtual camera array according to the spatial coordinate of the eye position (or viewpoint center) of the single observer V, so that the images of each view correspond to the eye position of the single observer V. In more detail, as shown in FIG. 1 and FIG. 5, the virtual camera array may, for example, comprise a first virtual camera C1, a second virtual camera C2, a third virtual camera C3, a fourth virtual camera C4, a fifth virtual camera C5, and a sixth virtual camera C6, with their spatial coordinates being (x1, y1, z1), (x2, y2, z2), (x3, y3, z3), (x4, y4, z4), (x5, y5, z5), and (x6, y6, z6), respectively. By having the processing unit 2 adjust the optical axis offset of each virtual camera (including the first virtual camera C1, the second virtual camera C2, the third virtual camera C3, the fourth virtual camera C4, the fifth virtual camera C5, and the sixth virtual camera C6), the field of view of each virtual camera can be aligned with the spatial coordinates of the four corner points of the virtual display plane P and/or the field of view of each virtual camera can be substantially overlapped with the virtual display plane P, so that the autostereoscopic three-dimensional display 3 can adjust the display pixels according to the data provided by the processing unit 2, thereby generating multi-view images. In this way, the autostereoscopic three-dimensional display 3 (as shown in FIG. 1) can satisfy multiple observers viewing the three-dimensional image simultaneously.

Similar to the foregoing, when the left viewpoint PL and the right viewpoint PR of the observer V move, the spatial coordinate of the left viewpoint PL and the spatial coordinate of the right viewpoint PR are correspondingly set, and the spatial coordinate of each virtual camera in the virtual camera array is correspondingly set or updated according to the above spatial coordinates. By adjusting the optical axis offset of each virtual camera, the field of view of each virtual camera is kept aligned with the edge of the virtual display plane P. In this way, the three-dimensional image of the autostereoscopic three-dimensional display 3 (as shown in FIG. 1) can approach the real world.

In the present disclosure, FIG. 5 uses 6 virtual cameras (including the first virtual camera C1, the second virtual camera C2, the third virtual camera C3, the fourth virtual camera C4, the fifth virtual camera C5, and the sixth virtual camera C6) as a virtual camera array. In other embodiments, the virtual camera array may comprise an integer number of virtual cameras greater than 2, for example, 3, 4, 5, 7, 8, or 10, but the present disclosure is not limited thereto. In an embodiment, the distance between each virtual camera may be equal. In other words, the distance d1 between the first virtual camera C1 and the second virtual camera C2 may be equal to the distance d2 between the third virtual camera C3 and the fourth virtual camera C4 (i.e., d1=d2), the distance d1 between the first virtual camera C1 and the second virtual camera C2 may be equal to the distance d3 between the fifth virtual camera C5 and the sixth virtual camera C6 (i.e., d1=d3), the distance d1 between the first virtual camera C1 and the second virtual camera C2 may be equal to the distance d4 between the first virtual camera C1 and the fourth virtual camera C4 (i.e., d1=d4), and the distance d1 between the first virtual camera C1 and the second virtual camera C2 may be equal to the distance d5 between the second virtual camera C2 and the fifth virtual camera C5 (i.e., d1=d5), but the present disclosure is not limited thereto. In other embodiments, the distance between each virtual camera can be adjusted as needed. In other words, the distances d1, d2, d3, d4, and d5 can be equal or unequal to each other.

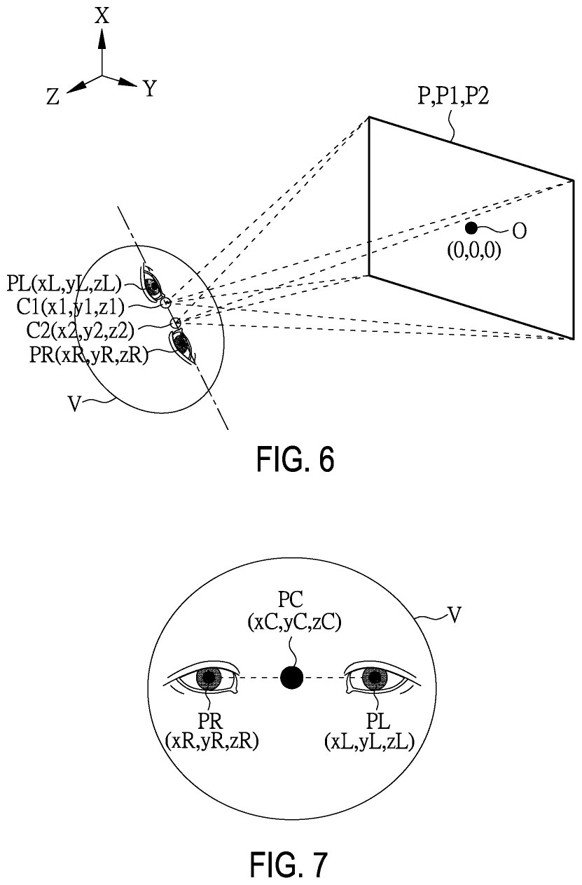

FIG. 6 is a schematic diagram of a setting method for three-dimensional image capture according to an embodiment of the present disclosure. FIG. 7 is a schematic diagram of a viewpoint center according to an embodiment of the present disclosure.

In an embodiment of the present disclosure, as shown in FIG. 1, FIG. 2, and FIG. 6, in step S2, the processing unit 2 setting the spatial coordinates of the at least two virtual cameras according to the spatial coordinate of the left viewpoint PL and the spatial coordinate of the right viewpoint PR may comprise calculating the spatial coordinates of the at least two virtual cameras according to a scaling factor. More specifically, the processing unit 2 may calculate the spatial coordinates of the first virtual camera C1 and the second virtual camera C2 according to the following formulas:

(x1,y1,z1)=((xL, yL, zL)−(xC, yC, zC))*S+(xC, yC, zC)

(x2,y2,z2)=((xR, yR, zR)−(xC, yC, zC))*S+(xC, yC, zC)

wherein (x1,y1,z1) is the spatial coordinate of the first virtual camera C1, (x2, y2,z2) is the spatial coordinate of the second virtual camera C2, (xL, yL, zL) is the spatial coordinate of the left viewpoint PL, (xR, yR, zR) is the spatial coordinate of the right viewpoint PR, (xC, yC, zC) is a spatial coordinate of a viewpoint center PC of the observer V, and S is the scaling factor.

By setting the value of the scaling factor (S), the display intensity of the three-dimensional image can be adjusted. Specifically, when the scaling factor is equal to 0, the spatial coordinates of the first virtual camera C1 and the second virtual camera C2 will converge to the viewpoint center PC, corresponding to a two-dimensional (2D) image display; when the scaling factor is greater than 0 and less than 1 (i.e., 0<S<1), a weak three-dimensional image is displayed to reduce eye fatigue; when the scaling factor is equal to 1 (i.e., S=1), a normal three-dimensional image is displayed, and its stereoscopic effect is close to the real world; when the scaling factor is greater than 1 and less than or equal to 2 (i.e., 1<S≤2), a strong three-dimensional image is displayed to enhance the stereoscopic effect. The maximum value of the scaling factor can be set according to requirements (for example, less than or equal to 10). By setting the value of the scaling factor, the display intensity of the three-dimensional image can be adjusted, thereby improving the situation where the observer V cannot tolerate the three-dimensional image or enhancing the display effect of the three-dimensional image. More specifically, when the scaling factor is equal to 1, the spatial coordinate of the first virtual camera C1 may be substantially the same as the spatial coordinate of the left viewpoint PL, and the spatial coordinate of the second virtual camera C2 may be substantially the same as the spatial coordinate of the right viewpoint PR, that is, (x1, y1, z1) may be substantially equal to (xL, yL, zL), and (x2, y2, z2) may be substantially equal to (xR, yR, zR). At this time, the stereoscopic effect of the three-dimensional image is close to the real world. When the scaling factor is less than 1, the stereoscopic effect of the three-dimensional image can be reduced, thereby improving the eye fatigue and/or discomfort caused by the observer V viewing the stereoscopic image. At this time, as shown in FIG. 6, the spatial coordinate of the first virtual camera C1 is not equal to the spatial coordinate of the left viewpoint PL, and the spatial coordinate of the second virtual camera C2 is not equal to the spatial coordinate of the right viewpoint PR, that is, (x1, y1, z1) is not equal to (xL, yL, zL), and (x2, y2,z2) is not equal to (xR, yR, zR). When the scaling factor is greater than 1, the stereoscopic effect of the three-dimensional image can be enhanced. In the present disclosure, the scaling factor may be greater than 0 and less than or equal to 10, for example, it may be greater than 0 and less than or equal to 5, or greater than 0 and less than or equal to 2, but the present disclosure is not limited thereto. In an embodiment of the present disclosure, the observer V can set the value of the scaling factor as needed to adjust the display effect of the three-dimensional image. In an embodiment of the present disclosure, the processing unit 2 (as shown in FIG. 1) can independently adjust the position and/or other shooting parameters of the first virtual camera C1 and the second virtual camera C2 according to the spatial coordinates of the left viewpoint PL and the right viewpoint PR of the observer V, respectively.

Referring to FIG. 7, in the present disclosure, the “left viewpoint PL” refers to, for example, the center point of the left pupil of the observer V, and the “right viewpoint PR” refers to, for example, the center point of the right pupil of the observer V. The “viewpoint center PC” refers to, for example, the center point between the left viewpoint PL and the right viewpoint PR of the observer V. The processing unit 2 (as shown in FIG. 1) can calculate the spatial coordinate of the viewpoint center PC of the observer V according to the following formula:

(xC, yC, zC)=((xL, yL, zL)+(xR, yR, zR))/2.

The present disclosure, by keeping the field of view of the virtual cameras aligned with the edge of the virtual display plane P during three-dimensional image capture, allows the three-dimensional image generated by the autostereoscopic three-dimensional display 3 to approach the real world. In addition, by setting the value of the scaling factor, the display intensity of the three-dimensional image can be adjusted, thereby improving the situation where the observer cannot tolerate the three-dimensional image or enhancing the display effect of the three-dimensional image.

The specific embodiments above should be construed as merely illustrative and not in any way limiting the remainder of this disclosure.

What is claimed is:

1. A setting method for three-dimensional image capture, comprising:
obtaining a spatial coordinate of a left viewpoint and a spatial coordinate of a right viewpoint of at least one observer;
setting spatial coordinates of at least two virtual cameras according to the spatial coordinate of the left viewpoint and the spatial coordinate of the right viewpoint, wherein the at least two virtual cameras comprise a first virtual camera and a second virtual camera; and
adjusting an optical axis offset of the first virtual camera and the second virtual camera, such that a field of view of the first virtual camera is aligned with an edge of a virtual display plane, and the field of view of the second virtual camera is aligned with the edge of the virtual display plane.

2. The setting method of claim 1, wherein when the left viewpoint and the right viewpoint of the at least one observer move, the spatial coordinates of the at least two virtual cameras are correspondingly set, such that the field of view of the first virtual camera and the field of view of the second virtual camera are kept aligned with the edge of the virtual display plane.

3. The setting method of claim 1, wherein the step of setting the spatial coordinates of the at least two virtual cameras comprises calculating the spatial coordinates of the at least two virtual cameras according to a scaling factor.

4. The setting method of claim 3, wherein the spatial coordinates of the first virtual camera and the second virtual camera are calculated according to the following formulas:
(x1,y1,z1)=((xL, yL, zL)−(xC, yC, zC))*S+(xC, yC, zC)
(x2,y2,z2)=((xR, yR, zR)−(xC, yC, zC))*S+(xC, yC, zC)
wherein (x1,y1,z1) is the spatial coordinate of the first virtual camera, (x2,y2,z2) is the spatial coordinate of the second virtual camera, (xL, yL, zL) is the spatial coordinate of the left viewpoint, (xR, yR, zR) is the spatial coordinate of the right viewpoint, (xC, yC, zC) is a spatial coordinate of a viewpoint center of the observer, and S is the scaling factor.

5. The setting method of claim 4, wherein the scaling factor is greater than 0 and less than or equal to 10.

6. The setting method of claim 5, wherein the scaling factor is greater than 0 and less than or equal to 5.

7. The setting method of claim 4, wherein the spatial coordinate of the viewpoint center of the observer is calculated according to the following formula:
(xC, yC, zC)=((xL, yL, zL)+(xR, yR, zR))/2.

8. The setting method of claim 1, wherein the step of aligning the field of view of the first virtual camera and the field of view of the second virtual camera with the edge of the virtual display plane comprises aligning the field of view of the first virtual camera with spatial coordinates of four corner points of the virtual display plane, and aligning the field of view of the second virtual camera with the spatial coordinates of the four corner points of the virtual display plane.

9. The setting method of claim 1, wherein a size of the virtual display plane is the same as a size of an autostereoscopic three-dimensional display.

10. The setting method of claim 1, further comprising:
setting a spatial coordinate of a virtual camera array according to the spatial coordinates of the at least two virtual cameras; and
adjusting an optical axis offset of each virtual camera in the virtual camera array, such that a field of view of each virtual camera in the virtual camera array is aligned with the edge of the virtual display plane, thereby causing an autostereoscopic three-dimensional display to generate multi-view images.

11. A system for three-dimensional image capture, comprising:
a sensing unit configured to obtain a spatial coordinate of a left viewpoint and a spatial coordinate of a right viewpoint of at least one observer; and
a processing unit, communicatively coupled to the sensing unit, wherein the processing unit is configured to:
set spatial coordinates of at least two virtual cameras according to the spatial coordinate of the left viewpoint and the spatial coordinate of the right viewpoint, wherein the at least two virtual cameras comprise a first virtual camera and a second virtual camera; and
adjust an optical axis offset of the first virtual camera and the second virtual camera, such that a field of view of the first virtual camera is aligned with an edge of a virtual display plane, and the field of view of the second virtual camera is aligned with the edge of the virtual display plane.

12. The system of claim 11, wherein when the left viewpoint and the right viewpoint of the at least one observer move, the processing unit updates a setting of the spatial coordinates of the at least two virtual cameras according to a change in the spatial coordinate of the left viewpoint and the spatial coordinate of the right viewpoint obtained by the sensing unit.

13. The system of claim 11, wherein the processing unit is configured to calculate the spatial coordinates of the at least two virtual cameras according to a scaling factor.

14. The system of claim 13, wherein the processing unit is configured to calculate the spatial coordinates of the first virtual camera and the second virtual camera according to the following formulas:
(x1,y1,z1)=((xL, yL, zL)−(xC, yC, zC))*S+(xC, yC, zC)
(x2,y2,z2)=((xR, yR, zR)−(xC, yC, zC))*S+(xC, yC, zC)
wherein (x1,y1,z1) is the spatial coordinate of the first virtual camera, (x2,y2,z2) is the spatial coordinate of the second virtual camera, (xL, yL, zL) is the spatial coordinate of the left viewpoint, (xR, yR, zR) is the spatial coordinate of the right viewpoint, (xC, yC, zC) is a spatial coordinate of a viewpoint center of the observer, and S is the scaling factor.

15. The system of claim 14, wherein the scaling factor is greater than 0 and less than or equal to 10.

16. The system of claim 15, wherein the scaling factor is greater than 0 and less than or equal to 5.

17. The system of claim 14, wherein the processing unit is configured to calculate the spatial coordinate of the viewpoint center of the observer according to the following formula:
(xC, yC, zC)=((xL, yL, zL)+(xR, yR, zR))/2.

18. The system of claim 11, further comprising an autostereoscopic three-dimensional display communicatively coupled to the processing unit, wherein a size of the autostereoscopic three-dimensional display is the same as a size of the virtual display plane.

19. The system of claim 18, wherein the processing unit is further configured to:
set a spatial coordinate of a virtual camera array according to the spatial coordinates of the at least two virtual cameras; and
adjust an optical axis offset of each virtual camera in the virtual camera array, such that a field of view of each virtual camera in the virtual camera array is aligned with the edge of the virtual display plane, thereby causing the autostereoscopic three-dimensional display to generate multi-view images.

20. The system of claim 11, wherein the sensing unit is an eye tracker.
